(19) United States
(12) Patent Application Publication
(10) Pub. No.: US 2017/0358975 A1
(43) Pub. Date: Dec. 14, 2017

(54) Adjustment Unit

(71) Applicant: SAF-HOLLAND GmbH, Bessenbach (DE)

(72) Inventor: Olaf Drewes, Aschaffenburg (DE)

(73) Assignee: SAF-HOLLAND GmbH, Bessenbach (DE)

(21) Appl. No.: 15/540,182

(22) PCT Filed: Feb. 9, 2016
(86) PCT No.: PCT/EP2016/052673

§ 371 Date: Jun. 27, 2017

(30) Foreign Application Priority Data
Feb. 16, 2015 (DE) 10 2015 202 744.9

(51) Int. Cl. H02K 21/22; H02K 21/14; H02K 7/102; H02K 37/24; F16D 65/38; H02K 37/12; F16D 65/18

(52) U.S. Cl. CPC H02K 21/227; H02K 7/1021; H02K 21/145; H02K 37/24; H02K 37/12; F16D 65/18; F16D 2065/386

(57) ABSTRACT

An adjustment unit, particularly for use in a commercial vehicle brake, comprising a stator and a rotor, wherein the stator and/or rotor have a coil arrangement, wherein the rotor is mounted in such a way that it can rotate about an actuation axis relative to the stator, and the stator is secured in such a way that it cannot rotate about the actuation axis relative to a main body, wherein it is possible to generate, in the coil arrangement, a magnetic field which rotates the rotor relative to the stator, wherein the rotor is in engagement with a first transmission section in such a way that a rotation of the rotor results in shifting of the first transmission section relative to the stator along the actuation axis.

### BACKGROUND OF THE INVENTION

The present invention relates to an adjustment unit, particularly for use in a commercial vehicle brake.

Adjustment units for use in commercial vehicle brakes are known from the prior art. In adjustment units of this kind, mechanical elements are provided, by means of which the adjustment unit adapts the brake system to wear of the friction pads. In other words, the adjustment devices are used to keep down the distance traveled by the brake shoes or brake pads when a braking process is initiated and thus also to minimize the response time of the brake system. Hitherto, adjustment units have been designed as purely mechanically driven systems, wherein, for example, a spring element or a combination of different spring elements with a clutch element allows stepwise adjustment of the brake system. The adjustment units known from the prior art are prone to faults and expensive to produce, require an excessive amount of installation space and have an excessive weight.

It is the object of the present invention to provide an adjustment unit which is simple to produce, reliable, space-saving and lightweight.

### SUMMARY OF THE INVENTION

According to the invention, the adjustment unit comprises a stator and a rotor, wherein the stator and/or rotor have a coil arrangement, wherein the rotor is mounted in such a way that it can rotate about an actuation axis relative to the stator, and the stator is secured in such a way that it cannot rotate about the actuation axis relative to a main body, wherein it is possible to generate, in the coil arrangement, a magnetic field which rotates the rotor relative to the stator, wherein the rotor is in engagement with a first actuation element in such a way that a rotation of the rotor relative to the actuation element results in shifting of the actuation element relative to the rotor along the actuation axis. The adjustment unit is preferably a subsystem of a brake system of a motor vehicle, particularly preferably of a commercial vehicle. At least two elements that can be turned or rotated relative to one another, a stator and a rotor, are provided in the adjustment unit. In order to impart a relative rotary motion of the stator and rotor with respect to one another, the adjustment unit has a coil arrangement, which is designed to generate a magnetic field that causes a torque to act between the rotor and the stator. In other words, the combination of the stator and the rotor thus acts as an electric motor, which produces a torque that causes rotation of the rotor relative to the stator. The rotor is in engagement with a first transmission section in such a way that rotation of the rotor relative to the stator results in shifting of the first transmission section relative to the stator. In the simplest case, the first transmission unit can be an end face of the rotor, said end face being designed in such a way that it can transmit an actuating force of a brake to a shoe element, for example. Here, there is a preference for the first transmission unit to intersect or to be situated on the actuation axis. Moreover, the engagement between the rotor and the first transmission section can also be indirect, it being the case, for example, that an additional element or an additional section is arranged between the transmission section and the rotor, triggering a shifting movement along the actuation axis between the rotor and the first transmission section. In the context of the present invention, the shifting of the first transmission section relative to the stator advantageously causes a change in the length of the adjustment unit, measured along the actuation axis or preferably parallel to the actuation axis. Here, this enlargement of the distance between the first transmission section and a stator surface facing away from the first transmission section and furthest away from the first transmission section is preferably used to compensate wear of brake shoe elements. In other words, relative to the stator, the first transmission section can be screwed out of the stator or into the latter, either directly via the rotor or indirectly via an additional interposed element. In the context of the present invention, no further mechanical force transmission elements are preferably required, all that is necessary to achieve the corresponding change in the length of the adjustment unit along the actuation axis being the rotation of the rotor relative to the stator and the provision of a thread, either between the rotor and the stator or between the rotor and an additional element arranged between the rotor and the transmission section. In this way, particularly simple and lightweight construction of the adjustment unit is possible. Owing to the absence of additional mechanical components, the susceptibility of the adjustment unit to faults in the sense according to the present invention is also particularly low. By virtue of the particularly compact design, the adjustment unit can preferably be integrated into already existing disk brakes or drum brake systems. In this case, the force transmission piston of a wedge brake can preferably be replaced by an adjustment unit in the sense according to the present invention. The stator preferably has the same external dimensions, that is to say advantageously the same outside diameter, as the force transmission piston of a conventional wedge-type drum brake. In a conventional disk brake too, the force transmission member which transmits the braking force from an actuation unit, e.g. a brake cylinder or a lever connected thereto, to the brake shoes, can be replaced by an adjustment unit comprising at least one stator and a rotor and a transmission section in the sense according to the present invention. The adjustment unit preferably performs the task not only of compensating the wear of the brake pads but also that of compensating the wear of the brake disk or of the brake drum. In addition to adjustment, the adjustment unit also performs the return function. In particular, the arrangement of the stator and rotor acting as a motor can act in both directions of rotation. Here, return can be achieved by rotation of the rotor and of the stator in such a way that the rotor is screwed into the stator or into an additional element. In this way, the adjustment unit preferably also serves to compensate the disadvantage inherent in a drum brake system that the drum expands during braking and cools after braking, contracting again as it does so. For this purpose, the brake system of the commercial vehicle can perform adjustment or return at the adjustment unit, depending on the temperature of the brake drum, simply by selecting one of the two directions of rotation between the rotor and the stator. By means of this procedure, the brake system can be prevented from running hot, something that occurred in a conventional path-controlled adjustment if adjustment was excessive.

In a preferred embodiment, the stator and the rotor are arranged at least partially, preferably predominantly, within a space defined by the main body. The main body is preferably part of a housing of a brake caliper or of a wedge unit of a drum brake. In this case, the main body advantageously has a recess in which the stator is arranged and preferably secured against shifting transversely to the actuation axis. Engagement means are advantageously provided in the recess in the main body, said engagement means securing the stator against rotation about the actuation axis but simultaneously permitting shifting of the stator along the actuation axis relative to the main body. It is particularly preferred for the stator and the rotor to be arranged at least partially within the main body and thus within the recess in the main body. In this way, a compact construction of the overall brake system can be achieved since the adjustment unit in the sense according to the present invention does not require any external components, in other words components situated outside the housing or the main body. This is a significant difference with respect to adjustment units known from the prior art, in which drive elements, e.g. mechanical or electric drives and transmission shafts, are arranged outside the housing of a brake caliper or a wedge unit and transmit a force into the actual adjustment unit via shafts. Moreover, the main body also offers protection against the penetration of dirt and foreign bodies into the composite structure comprising the stator and the rotor. For this purpose, corresponding sealing elements can preferably be provided between the main body and the stator or between the main body and the rotor. As a particular preference, the stator and the rotor are predominantly arranged within a space defined by the main body, that is to say, in other words, preferably with at least 50 percent, in particular preferably with at least 80 percent, of their length along the actuation axis within a space defined by the main body. As a particular preference, the stator and rotor are arranged completely within the main body. In this way, it is possible to secure the adjustment unit completely against the penetration of dirt and foreign bodies and simultaneously to achieve the maximum saving of installation space by virtue of a very compact construction.

In another preferred embodiment, the rotor is arranged predominantly within a space defined by the stator. As a particular preference, the rotor is therefore arranged in a recess in the stator, wherein, in a particularly preferred case, at least half of the extent of the rotor along the actuation axis is arranged within this recess in the stator. It is possible to achieve a particularly compact construction of the adjustment unit not only through the arrangement of the stator and of the rotor within the main body but also through the particularly compact design of the composite structure comprising the stator and the rotor. Here, the space defined by the stator is preferably defined as the volume defined by the external geometry of the stator. Similarly, the volume defined by the main body is in other words the volume enclosed by the external dimensions of the main body.

In order to ensure the mode of operation of the rotor and of the stator as an electric drive, there is a requirement, in addition to the coil arrangement provided either on the rotor or on the stator, for at least one second coil arrangement or a permanent magnet on the other unit in each case. The rotor preferably has a permanent magnet. The advantage of a permanent magnet on the rotor is that it does not have to be supplied with an electric voltage, and therefore no sliding contacts are required to supply a voltage or to generate an electric current in coils on the rotor. However, in the case where a relatively high power or a relatively high torque has to be generated between the rotor and the stator, there may also be a preference for the provision of a second coil arrangement instead of a permanent magnet on the rotor since the magnetic field can be intensified once again by increasing the electric current in the coil arrangement, thus allowing a higher torque to be achieved between the rotor and the stator. In contrast, a permanent magnet offers the advantage that the rotor can be of particularly simple design, and there is no need for a sliding contact and thus also for wear in the region of the support between the rotor and the stator.

In a particularly preferred embodiment, the rotor and the stator, together with the coil arrangement and a permanent magnet or two coil arrangements, form a stepper motor, wherein the coil arrangement has at least four windings distributed around the actuation axis. In this context, the stepper motor employs a principle known from the prior art, in which a motor having a certain number of individual coils or windings performs a certain rotational step through a respective precisely defined angle when a voltage is applied in one or in a certain number of the windings. In accordance with the division of the coil arrangement into a multiplicity of windings, the element arranged on the rotor, a permanent magnet or second coil arrangement, preferably also has a multi-part design. A permanent magnet is preferably divided into at least two parts. As an alternative, the second coil arrangement arranged on the rotor has at least two windings. It is self-evident that the adjustment steps of the adjustment unit can be made smaller by increasing the number of windings, but the complexity of the electrical connections of the adjustment unit increases, as does therefore also the weight and susceptibility to faults. Within the context of the present invention, it has been found that a coil arrangement of no more than eight windings on the stator and a corresponding division of the permanent magnet or of the second coil arrangement on the rotor into no more than six parts is advantageous. In this way, it was possible to achieve all the required sizes of adjustment steps on the adjustment unit in tests carried out in the context of the present invention, wherein the torque between the stator and the rotor simultaneously had sufficiently high values by virtue of the possibility of using two windings simultaneously.

It is advantageous if the stator has a second transmission section, wherein an actuating force of an actuating unit acting along the actuation axis can be received at the first transmission section or the second transmission section and transmitted in the other of the sections in each case, the first or the second transmission section, to a shoe element. The second transmission section is preferably an end face of the stator in relation to the extent thereof along the actuation axis. It is advantageous here if the second transmission section has a hardened surface, for example, which is capable of absorbing high forces from an actuating unit while, at the same time, suffering low wear and low friction, and of transmitting these to a shoe element. In a preferred embodiment, in which a linkage of a brake cylinder acts on the second transmission section in order to transmit the force of the brake cylinder to the brake shoe arrangement of a disk brake caliper, the second transmission section preferably has a concave recess, into which the linkage can engage and in which it is secured against slipping out from the engagement region between the stator and the linkage.

In a particularly preferred embodiment, the first transmission section is part of an actuation element, wherein the actuation element is mounted in such a way that it can rotate relative to the rotor and is in engagement with the rotor via a thread. Particularly in the case in which the position of the rotor along the actuation axis is not supposed to change relative to the stator, that is to say where the rotor is not in engagement with the stator via a thread, it is preferred if an actuation element which is in engagement with the rotor via a thread is provided. In this way, it is possible to achieve a rotary motion of the rotor relative to the stator in a longitudinal movement of the actuation element in relation to the actuation axis. In this case, the first transmission element is preferably the end face of the actuation element in relation to the actuation axis. Although the provision of an actuation element produces additional weight in the adjustment unit, it is simultaneously possible to increase the efficiency of the coil arrangement since no shifting movement of the rotor relative to the stator along the actuation axis is required to produce a change in the length of the composite structure comprising the stator, the rotor and the actuation element. At the same time, a rotation of the actuation element and thus of the transmission section relative to the shoe element or relative to the actuating unit is not required, and therefore frictional wear on the surface of the first transmission section can be avoided. In this way, it is possible to significantly increase the life of the adjustment unit.

As a particular preference, rotation of the rotor about the actuation axis relative to the actuation element brings about a change in the extent of the composite structure comprising the actuation element, the rotor and the stator along the actuation axis. In order to bring about this change in the length of the composite structure comprising the actuation element, the rotor and the stator, a thread is advantageously arranged between the rotor and the actuation element, said element bringing about a lateral movement along the actuation axis between the rotor and the actuation element when the rotor is rotated relative to the actuation element.

The rotor is preferably secured against shifting along the actuation axis relative to the stator. In order to hold the rotor in the position thereof relative to the stator, in particular in order to hold constant the coil arrangement on the stator and the second coil arrangement provided on the rotor or the second coil arrangement provided on the rotor or the permanent magnet provided on the rotor. In this case, a snap ring can be provided, for example, said ring engaging on the rotor and securing the latter against being shifted relative to the stator along the actuation axis. In this way, the efficiency of the electric drive can be increased by the coil arrangement.

It is advantageous if the actuation element has a securing section, which is in engagement with a main-body anti-rotation safeguard or with a shoe anti-rotation safeguard in order to secure the actuation element against rotation about the actuation axis relative to the main body and/or relative to a shoe element. To prevent the actuation element from simply corotating when the rotor rotates, a securing section is preferably provided, which is in engagement either with a main-body anti-rotation safeguard, which is arranged on the main body, or with a shoe anti-rotation safeguard, which is provided on a shoe element. Here, the main-body anti-rotation safeguard can advantageously be a projection which engages in a securing section, preferably formed as a groove in the actuation element, and, while allowing shifting of the actuation element along the actuation axis, prevents rotation of the actuation element about the actuation axis relative to the main body. As an alternative preference, the actuation element preferably has a groove or a corresponding engagement geometry in the region of the first transmission section, said groove or geometry being in engagement with a shoe element in order once again to prevent rotation of the actuation element relative to the shoe element. In this case, the occurrence of rotation of the actuation element relative to the shoe element and thus the occurrence of wear on the surfaces of the shoe element and of the first transmission section which are pressed onto one another are prevented, in particular.

It is advantageous if the actuation element comprises an actuation bolt, which engages by means of an external thread in an internal thread on a rotor recess of the rotor. It is thus advantageous if the engagement region of the rotor is embodied as a recess with an internal thread, into which an actuation-element section embodied as an actuation bolt engages, preferably being screwed in. The advantage of this embodiment is that the coil arrangement, advantageously arranged on the outer surface of the rotor, or the permanent magnet arranged on the outer surface of the rotor acts with a larger lever arm about the actuation axis than the internal thread on the rotor recess, and hence a higher circumferential force is achieved in the region of the thread between the rotor and the actuation bolt.

In an alternative embodiment, the actuation element has an actuation recess having an internal thread, which engages in an external thread of a rotor bolt of the rotor. Particularly if the coil arrangement or the permanent magnet of the rotor and the corresponding engagement region between the actuation element and the rotor are arranged offset relative to one another along the actuation axis, there may be a preference for the actuation element to have an actuation recess with an internal thread into which the rotor can be screwed. By enlarging the diameter of the thread, it is advantageously possible to transmit a larger force between the actuation element and the rotor with the same thread depth without the occurrence of damage to the thread. In this way, it is possible, in particular, to keep the thread cutting depth smaller than is the case with the above-described alternative embodiment of the actuation element with an actuation bolt, thereby advantageously reducing the outlay on the production of the adjustment unit. In the present case, this higher transmissible force between the actuation element and the rotor is achieved at the cost of a somewhat larger overall size of the composite structure comprising the actuation element and the rotor. Depending on the application, it is thus possible in the context of the present invention to select the appropriate design of the connecting region between the actuation element and the rotor in each case.

As a particular preference, the coil arrangement at least partially surrounds the rotor and has a mean coil diameter, wherein the engagement region between the rotor and the actuation element has a mean engagement diameter, wherein the mean engagement diameter is at most 0.8 times, preferably at most 0.6 times and particularly preferably about 0.3 to 0.5 times the mean coil diameter. The coil arrangement preferably surrounds the rotor along a cylindrical surface extending radially around the actuation axis. Here, the mean coil diameter is preferably considered to be the diameter at which the force acting in the circumferential direction about the actuation axis between the rotor and the stator takes effect in the physical sense. In a simplified view of the design, the mean coil diameter can be applied precisely centrally between the coil arrangement arranged on the stator and the permanent magnet provided on the rotor or the second coil arrangement provided on the rotor. The mean engagement diameter is preferably the diameter at which, in the physical sense, the force acting in the circumferential direction about the actuation axis acts in the thread provided between the actuation element and the rotor. It has been found that, by providing a lever arm designed in such a way that the mean engagement diameter is at most 0.8 times the mean coil diameter, a good compromise between high torques acting in the thread and, at the same time, a small installation space requirement for the adjustment unit can be achieved. In the case of a ratio of less than 0.6, a very high torque can preferably be generated, while the installation space requirement for the adjustment unit can nevertheless be kept so small. As a result, the adjustment unit can readily be retrofitted in brake systems known from the prior art. The highest torques in the thread can be achieved in the particularly preferred ratio range of 0.3-0.5, while, at the same time, the installation space requirement for the adjustment unit, although somewhat larger than in the above-described embodiments owing to a larger diameter of the coil arrangement, is nevertheless associated with a relatively compact design of the adjustment unit according to tests by the applicant.

In the preferred embodiment in which no actuation element is provided, it is preferred if the coil arrangement at least partially surrounds the rotor and has a mean coil diameter, wherein the engagement region between the rotor and the stator has a mean engagement diameter, wherein the mean engagement diameter is at most 0.9 times, preferably at most 0.75 times, and particularly preferably 0.5-0.7 times the mean coil diameter. The advantages of a particular ratio between the mean engagement diameter and the mean coil diameter which have been described for the preferred embodiment with an actuation element also apply to the embodiment without an actuation element. The size ratios provided in the context of the present invention achieve a good compromise between a high actuating force in the thread and a compact construction of the adjustment unit.

In a preferred embodiment, the main body is part of a housing of a wedge brake or of a brake caliper, wherein the main body has an opening, through which a cable for supplying power to the coil arrangement can be passed. As a particular preference, an opening, through which a cable for supplying power to the coil arrangement can be passed, is provided in the main body in the region of the support of the stator. As a particular preference, this opening is designed as an elongate hole in order to allow the power to be supplied easily to the coil arrangement during a shift of the stator along the actuation axis during a braking process. As an alternative preference, a sliding contact could also be provided in the main body, at which contact a corresponding contact on the stator transmits the corresponding voltage to the coil arrangement in sliding fashion.

In a particularly preferred embodiment, the thread provided between the actuation element and the rotor or between the rotor and the stator is a self-locking thread. A self-locking thread ensures that, when there is no voltage in the coil arrangement, the adjustment unit does not unintentionally reset, thus leading to excessive play in the brake system. In particular, the self-locking thread is distinguished by a very low rise or a low thread pitch, which, in addition to the self-locking effect, also has the advantage that a large force acting along the actuation axis and bringing about adjustment between the actuation element or rotor and, respectively, the stator can be achieved with a relatively low torque in the thread.

### BRIEF DESCRIPTION OF THE DRAWINGS

Further advantages and features of the present invention will become apparent from the following description with reference to the attached figures. It is self-evident that individual features respectively explained for just one embodiment described in the figures can also be used in other embodiments in other figures unless this has been explicitly excluded or is impossible owing to technical circumstances. In particular, it is possible here for the features explained in relation to an adjustment device without an actuation element also to be used in the embodiments with an actuation element and vice versa unless this is explicitly excluded or technically not worthwhile. In the drawing:

FIG. 1 shows a schematic view of a preferred embodiment of the adjustment unit according to the invention without actuation element;

FIG. 2 shows a view of the adjustment unit shown in FIG. 1 in the extended state;

FIG. 3 shows a schematic and partially sectioned view of two adjustment units in the sense according to the present invention for use in a wedge brake;

FIG. 4 shows a partially sectioned view of an alternative embodiment of the adjustment unit illustrated in FIG. 3;

FIG. 5 shows a partially sectioned view of an adjustment unit for use in a disk brake system; and

FIG. 6 shows a sectional view of an alternative embodiment of the adjustment unit illustrated in FIG. 5.

### DETAILED DESCRIPTION OF THE PREFERRED EMBODIMENTS

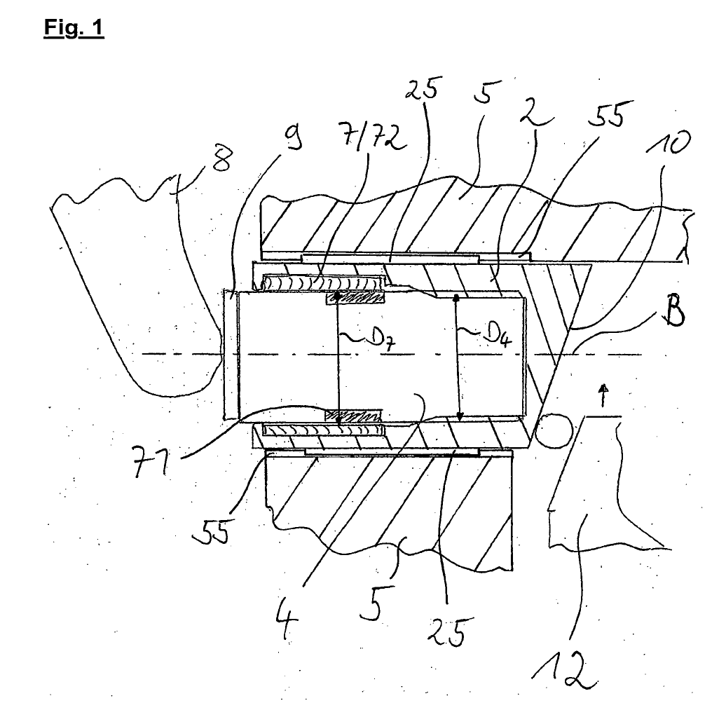

FIG. 1 shows a first preferred embodiment of the adjustment unit according to the invention, in which a stator 2 is mounted in a recess in a main body 5 in such a way that it can be shifted along an actuation axis B. A rotor 4 is preferably arranged substantially within a recess in the stator 2, said rotor being supported on the stator via a thread. In this case, the rotor 4 has on its end face facing outward or to the left in the figure a first transmission section 9, via which a supporting force can be transmitted to a shoe element 8 along the actuation axis B. On the opposite side from the first transmission section 9, the composite structure comprising the stator 2 and the rotor 4 has a second transmission section 10, which in the present case is preferably designed as an oblique surface, which is capable of absorbing a force of an actuating unit 12. In the present example, the actuating unit 12 is preferably a wedge unit, which transmits a force to the stator 2 along the actuation axis B in order to press the composite structure comprising the stator 2 and the rotor 4 against the shoe element 8. In order to prevent rotation of the stator 2 within the opening of the main body 5, the stator 2 has a stator anti-rotation safeguard 25 or a securing section 65, which engages in a corresponding main-body anti-rotation safeguard 55 and allows the possibility of shifting along the actuation axis but, at the same time, prevents rotation of the stator 2 about the actuation axis B. On its inside, the stator 2 has a coil arrangement 7, which, in the present case, preferably consists of four windings 72. Arranged on the rotor is a permanent magnet 71, which is arranged in such a way that a magnetic field generated in the windings 72 generates a torque in the permanent magnet 71 about the actuation axis B. In this way, it is possible, by applying a voltage and by generating an electric current in the coil arrangement 7 or in the windings 72, to generate a magnetic field, which imparts rotation about the actuation axis B to the rotor 4 relative to the stator. During this rotation of the rotor 4, it is supported on a thread, via which it is fixed on the stator 2, wherein a shifting movement of the rotor 4 takes place parallel to the actuation axis B. In FIG. 1, the rotor 4 is illustrated in the position in which it is fully screwed into the stator 2. This position would be present if the brake shoe pads on the shoe element 8 had just been renewed and thus had no wear and adjustment of the rotor 4 in relation to the stator 2 was not yet necessary. The coil arrangement 7 has a mean coil diameter D₇, which, in the present case, is only slightly larger than the mean engagement diameter D₄ between the rotor 4 and the stator 2 in the thread connecting the two components. With the embodiment shown in FIG. 1, it is thus possible to achieve a particularly compact construction with an external geometry of the stator 2 which is substantially cylindrical (apart from the stator anti-rotation safeguard 25). As a particular preference, a friction-reducing material, which reduces the friction during rotation of the rotor 4 relative to the stator 2 and also relative to the shoe element 8, is provided in the first transmission section 9.

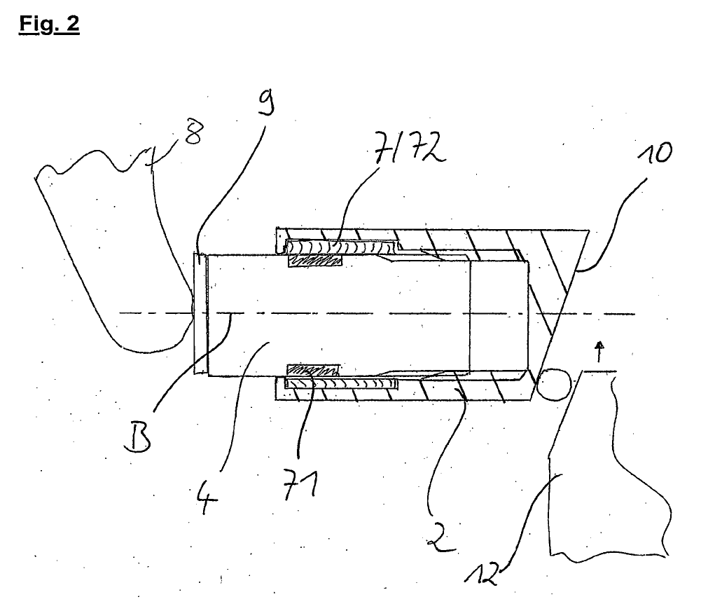

FIG. 2 shows the embodiment of the adjustment unit illustrated in FIG. 1, wherein the rotor 4 is illustrated in its position screwed out of the stator 2 to the maximum extent, this position being envisaged in operation. This position is thus preferably implemented in the adjustment unit when the brake shoe pads are almost completely worn away and should be replaced soon. FIGS. 1 and 2 also illustrate the fact that the permanent magnet 71, which is fixed on the rotor 4, has a smaller extent along the actuation axis B and shifts along the actuation axis relative to the coil arrangement 7 or to the windings 72 on the stator 2 during the process of unscrewing or screwing the rotor relative to the stator. One advantageous possibility in the embodiment of the adjustment unit shown in FIGS. 1 and 2 is to dispense with an additional actuation element 6 of the kind required in the embodiments described below. In FIGS. 1 and 2, the power supply to the coil arrangement 7 or the windings 72 is not shown but it is self-evident that a cable can, of course, be passed through the stator 2 and passed out of the adjustment unit via an opening 51 (not shown) in the main body 5.

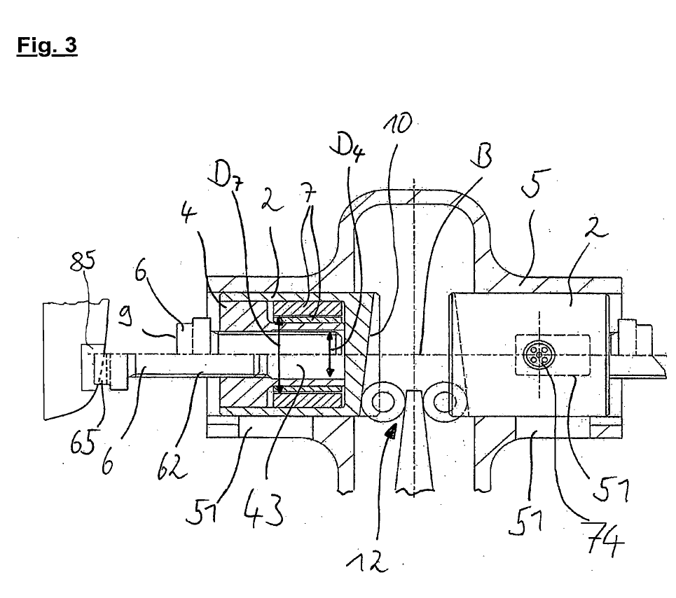

FIG. 3 shows another preferred embodiment of the adjustment unit according to the invention, wherein at least one stator 2 is arranged in such a way that it can be shifted along the actuation axis B in a main body 5, which is preferably the housing of a wedge unit. In the embodiment under consideration, in contrast to the embodiments of the adjustment unit according to the invention which are illustrated in FIGS. 1 and 2, an actuation element 6 is provided, which engages on the rotor 4 via a thread and is shifted relative to the rotor and to the stator 2 along the actuation axis by a rotation about the actuation axis. The advantage of this embodiment is that the coil arrangement 7 provided on the rotor 4 and on the stator 2 does not undergo a relative shifting movement along the actuation axis B, as in FIGS. 1 and 2, but can always be held precisely opposite. In this way, the coil arrangement 7 can be optimized for a maximum torque with a small overall size. Also illustrated is the fact that the mean coil diameter D₇ is larger than the mean engagement diameter. The ratio of the mean engagement diameter D₄ to the mean coil diameter D₇ is preferably about 0.5-0.6 since in this way a particularly high torque can be generated in the thread between the rotor 4 and the actuation element 6 and the overall size of the overall composite structure comprising the stator 2, the rotor 4 and the actuation element 6 can be kept particularly compact and small. In the embodiment shown in FIG. 3, the first transmission section 9 is not arranged on the rotor 4 but on the actuation element 6. As in the embodiments shown above, the second transmission section 10 is provided on the stator 2 and engages on an actuating unit 12. In the embodiment illustrated in FIG. 3, the rotor 4 has a rotor recess 43, in which a section of the actuation element 6 designed as an actuation bolt 62 with an external thread engages. In the case of the stator 2 (illustrated on the right in the figure, not in section), a terminal 74, which can be connected to a cable via an opening 51 designed as an elongate hole in the main body 5 in order to ensure the appropriate voltage for supplying the coil arrangement 7 with power, is illustrated schematically and turned through 90° about the actuation axis B. The opening 51 is preferably designed as an elongate hole in such a way that the shifting movement of the stator 2 along the actuation axis B during a braking process can be carried out together with the power cable which is connected to the terminal without it being sheared off in the region of the guide in the main body 5. In the region of the first transmission section 9, the actuation element 6 has a securing section 65, which is in engagement with the shoe anti-rotation safeguard 85 of a brake shoe 8. As an alternative or in addition to the engagement with the shoe anti-rotation safeguard 85, it is also possible to provide the engagement shown in FIG. 1 comprising a main-body anti-rotation safeguard 55 on the actuation element 6. For this purpose, the actuation element 6 preferably has, on the cylindrical outer surface thereof, a securing section 65 similar to the stator anti-rotation safeguard 25.

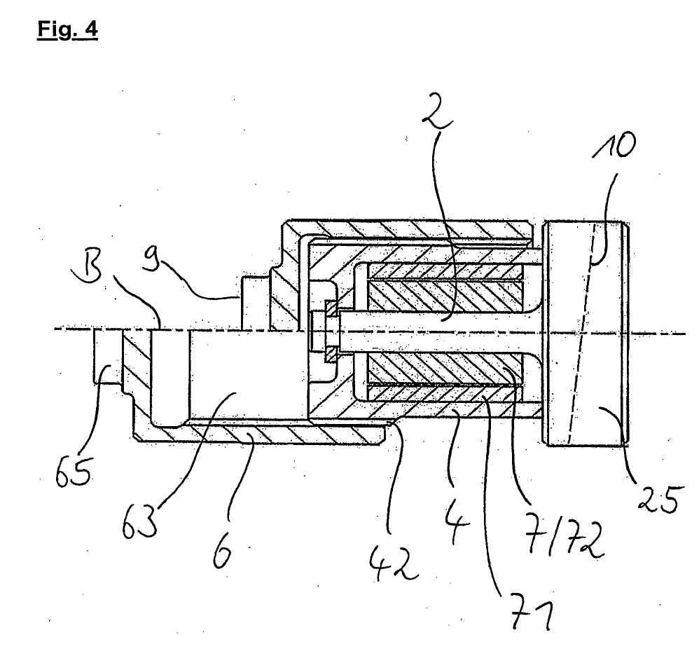

FIG. 4 shows an alternative embodiment of the composite structure comprising the stator 2, the rotor 4 and the actuation element 6, it being possible to use said embodiment in an adjustment unit in accordance with FIG. 3. In this case, the actuation element 6 has, instead of the actuation bolt 62, an actuation recess 63, which can be screwed on from outside via the rotor 4 and a rotor bolt 42 provided on the rotor. The stator 2 and the coil arrangement 7 provided on the stator 2 are arranged within a recess in the rotor 4. The advantage of this embodiment is that the actuation element 6 surrounds the rotor 4 and the stator 2 at least over a large area and thus protects them from external influences. A stator anti-rotation safeguard 25, by means of which the stator engages on an actuating unit 12 and is simultaneously secured against rotation about the actuation axis B, is furthermore illustrated in the region of the second transmission section 10. The rotor 4 and the stator 2 are preferably secured against shifting relative to one another along the actuation axis B. In the embodiment illustrated in FIG. 4, this is accomplished by means of a snap ring, which is seated in a corresponding groove in the region of the distal end of the stator 2, illustrated on the left in the figure. In this way, it is easily possible to preassemble the rotor 4 and the stator 2 as a drive unit for the adjustment unit in advance and then simply to screw the actuation element 6 onto the corresponding arrangement upon installation into a brake unit of a commercial vehicle. In the case of the embodiments illustrated in FIG. 3 and FIG. 4, the actuation element 6 preferably has a securing section 65 designed as a groove for engagement in a shoe anti-rotation safeguard 85 (see FIG. 3) in order to secure the actuation unit 6 against rotation relative to the shoe element 8 about the actuation axis B.

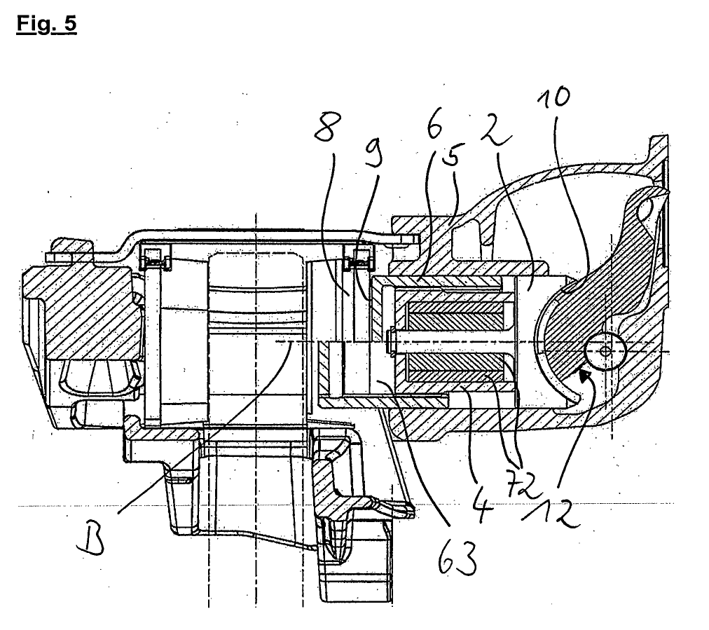

FIG. 5 shows a preferred embodiment of the adjustment unit for use in a disk brake system of a commercial vehicle. Here, the second transmission section 10 is not subjected to a force by a wedge unit, as in the embodiments shown above, but by an actuating unit 12, which in the present case comprises a lever, which is driven by a brake cylinder. In the embodiment shown in FIG. 5, the interaction of the elements—the actuation element 6, the rotor 4 and the stator 2—takes place in a manner similar to that in the embodiment shown in FIG. 4. In this embodiment, the shoe element 8 is preferably a brake pad of a disk brake system. In order to allow favorable force transmission from the actuating unit 12 to the stator 2, the second transmission unit 10 preferably has a concavely curved geometry.

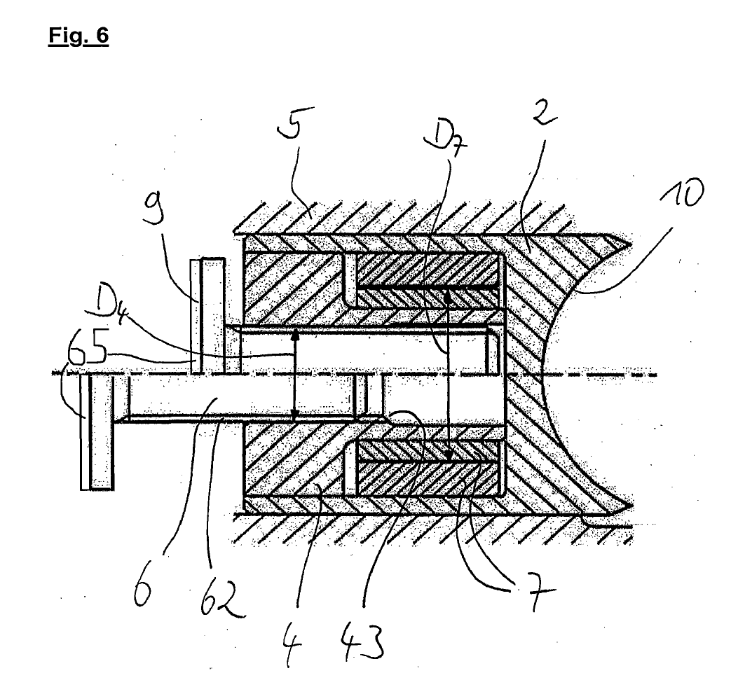

FIG. 6 shows an alternative embodiment of the composite structure comprising the stator 2, the rotor 4 and the actuation element 6 for use in the embodiment shown in FIG. 5. Here, the actuation element 6 is equipped with an actuation bolt 62, which engages in a rotor recess 43 having an internal thread in the rotor 4. In contrast to the embodiment shown in FIG. 5 therefore, the mean engagement diameter D₄ in the region of the thread between the rotor 4 and the actuation element 6 is smaller than the mean coil diameter D₇ of the coil arrangement 7 provided between the stator 2 and the rotor 4. In the embodiment shown in FIG. 6, the coil arrangement 7 thus generates a higher torque in the thread between the actuation element 6 and the rotor 4 than that in FIG. 5, for example, for the same voltage or the same current and thus the same magnetic field strength. The actuation element 6 in the embodiments shown in FIGS. 5 and 6 also preferably has a securing section 65.

### LIST OF REFERENCE SIGNS

2—stator
4—rotor
5—main body
6—actuation element
6—coil arrangement
8—shoe element
9—first transmission section
10—second transmission section
12—actuating unit
25—stator anti-rotation safeguard
42—rotor bolt
43—rotor recess
51—opening
55—main-body anti-rotation safeguard
62—actuation bolt
63—actuation recess
65—securing section
71—permanent magnet
72—windings
74—terminal
85—shoe anti-rotation safeguard
B—actuation axis
D₄ —mean engagement diameter
D₇ —mean coil diameter

1.-15. (canceled)

16. A brake adjustment unit, comprising:
a stator; and
a rotor;
wherein at least one of the stator and the rotor have a coil arrangement;
wherein the rotor is mounted to rotate about an actuation axis relative to the stator, and the stator is secured to prevent rotation about the actuation axis relative to a main body;
wherein the coil arrangement is configured to generate a magnetic field which rotates the rotor relative to the stator;
wherein the rotor is in engagement with a first transmission section such that a rotation of the rotor results in shifting of the first transmission section relative to the stator along the actuation axis;
wherein the stator has a second transmission section,
wherein an actuating force of an actuating unit acting along the actuation axis can be received at at least one of the first transmission section and the second transmission section and transmitted in the other of the first transmission section and the second transmission section to a shoe element.

17. The brake adjustment unit as claimed in claim 16, wherein the stator and the rotor are arranged at least partially within a space defined by the main body.

18. The brake adjustment unit as claimed in claim 17, wherein the stator and the rotor are arranged predominantly within the space defined by the main body.

19. The brake adjustment unit as claimed in claim 17, wherein the rotor is arranged predominantly within a space defined by the stator.

20. The brake adjustment unit as claimed in claim 19, wherein the rotor has a permanent magnet.

21. The brake adjustment unit as claimed in claim 20, wherein the rotor is secured against shifting along the actuation axis relative to the stator.

22. The brake adjustment unit as claimed in claim 21, wherein the stator and the rotor, together with at least one of the coil arrangement and a permanent magnet, and two coil arrangements, form a stepper motor, and wherein the coil arrangement has at least four windings distributed around the actuation axis.

23. The brake adjustment unit as claimed in claim 22, wherein the first transmission section is part of an actuation element, and wherein the actuation element is mounted such that the actuation element can rotate relative to the rotor and is in engagement with the rotor via a thread.

24. The brake adjustment unit as claimed in claim 23, wherein rotation of the rotor about the actuation axis relative to the actuation element brings about a change in the extent of the composite structure comprising the actuation element, the rotor and the stator along the actuation axis.

25. The brake adjustment unit as claimed in claim 24, wherein the actuation element has a securing section which is in engagement with at least one of a main-body anti-rotation safeguard and a shoe anti-rotation safeguard configured to secure the actuation element against rotation about the actuation axis relative to at least one of the main body and the shoe element.

26. The brake adjustment unit as claimed in claim 25, wherein the actuation element comprises an actuation bolt that includes an external thread which engages an internal thread on a rotor recess of the rotor.

27. The brake adjustment unit as claimed in claim 25, wherein the actuation element comprises an actuation recess having an internal thread, in which an external thread of a rotor bolt of the rotor engages.

28. The brake adjustment unit as claimed in claim 11, wherein the coil arrangement at least partially surrounds the rotor and has a mean coil diameter, wherein the engagement region between the rotor and the actuation element has a mean engagement diameter, and wherein the mean engagement diameter is at most 0.8 times the mean coil diameter.

29. The brake adjustment unit as claimed in claim 28, wherein the mean engagement diameter is at most 0.6 times the mean coil diameter.

30. The brake adjustment unit as claimed in claim 29, wherein the mean engagement diameter is between about 0.3 and about 0.5 times the mean coil diameter.

31. The brake adjustment unit as claimed in claim 28, wherein the main body is part of at least one of a housing of a wedge brake and of a brake caliper, and wherein the main body has an opening through which a cable for supplying power to the coil arrangement can be passed.

32. The brake adjustment unit as claimed in claim 31, wherein a self-locking thread is provided at least one of between the actuation element and the rotor and between the stator and the rotor.

33. The brake adjustment unit as claimed in claim 16, wherein the rotor is arranged predominantly within a space defined by the stator.

34. The brake adjustment unit as claimed in claim 16, wherein the rotor has a permanent magnet.

35. The brake adjustment unit as claimed in claim 16, wherein the rotor is secured against shifting along the actuation axis relative to the stator.

36. The brake adjustment unit as claimed in claim 16, wherein the stator and the rotor, together with at least one of the coil arrangement and a permanent magnet, and two coil arrangements, form a stepper motor, and wherein the coil arrangement has at least four windings distributed around the actuation axis.

37. The brake adjustment unit as claimed in claim 16, wherein the first transmission section is part of an actuation element, and wherein the actuation element is mounted such that the actuation element can rotate relative to the rotor and is in engagement with the rotor via a thread.

38. The brake adjustment unit as claimed in claim 37, wherein rotation of the rotor about the actuation axis relative to the actuation element brings about a change in the extent of the composite structure comprising the actuation element, the rotor and the stator along the actuation axis.

39. The brake adjustment unit as claimed in claim 37, wherein the actuation element has a securing section which is in engagement with at least one of a main-body anti-rotation safeguard and a shoe anti-rotation safeguard configured to secure the actuation element against rotation about the actuation axis relative to at least one of the main body and the shoe element.

40. The brake adjustment unit as claimed in claim 37, wherein the actuation element comprises an actuation bolt that includes an external thread which engages an internal thread on a rotor recess of the rotor.

41. The brake adjustment unit as claimed in claim 37, wherein the actuation element comprises an actuation recess having an internal thread, in which an external thread of a rotor bolt of the rotor engages.

42. The brake adjustment unit as claimed in claim 37, wherein the coil arrangement at least partially surrounds the rotor and has a mean coil diameter, wherein the engagement region between the rotor and the actuation element has a mean engagement diameter, and wherein the mean engagement diameter is at most 0.8 times the mean coil diameter.

43. The brake adjustment unit as claimed in claim 16, wherein the main body is part of at least one of a housing of a wedge brake and of a brake caliper, and wherein the main body has an opening through which a cable for supplying power to the coil arrangement can be passed.

44. The brake adjustment unit as claimed in claim 16, wherein a self-locking thread is provided at least one of between the actuation element and the rotor and between the stator and the rotor.
